(19) United States
(12) Patent Application Publication
(10) Pub. No.: US 2025/0322749 A1
(43) Pub. Date: Oct. 16, 2025

(54) SERVER

(71) Applicant: TOYOTA JIDOSHA KABUSHIKI KAISHA, Toyota-shi (JP)

(72) Inventors: Toshiki SHINOHARA, Toyota-shi (JP); Masataka OKUDA, Toyota-shi (JP); Kaoru YOSHIDA, Nisshin-shi (JP); Masatoshi KAKUTANI, Miyoshi-shi (JP); Kanade KURIYAMA, Toyota-shi (JP)

(73) Assignee: TOYOTA JIDOSHA KABUSHIKI KAISHA, Toyota-shi (JP)

(21) Appl. No.: 18/999,206

(22) Filed: Dec. 23, 2024

(30) Foreign Application Priority Data
Apr. 15, 2024 (JP) 2024-065623

(51) Int. Cl. G08G 1/0967; G08G 1/00; G08G 1/16; H04W 4/029; H04W 4/44

(52) U.S. Cl. CPC G08G 1/096725; G08G 1/164; G08G 1/20; H04W 4/029; H04W 4/44

(57) ABSTRACT

When the degree of impact of the first group is equal to or greater than the degree of impact of the second group, CPU transmits a deceleration request to the lead vehicles of the second group having a lower degree of impact. When the first group of impacts is less than the second group of impacts, CPU transmits a deceleration request to the first group of low degree of impact lead vehicles.

### CROSS-REFERENCE TO RELATED APPLICATION

This application claims priority to Japanese Patent Application No. 2024-065623 filed on Apr. 15, 2024, incorporated herein by reference in its entirety.

### BACKGROUND

### 1. Technical Field

The present disclosure relates to servers.

### 2. Description of Related Art

Japanese Unexamined Patent Application Publication No. 2017-167669 (JP 2017-167669 A) describes a communication system including vehicles and a server. When a plurality of vehicles travels as a group, the server transmits a control signal to the lead vehicle of the group. When the lead vehicle reaches a stop, the server transmits a signal for selecting a following vehicle as a control signal for the lead vehicle.

### SUMMARY

In the communication system described in JP 2017-167669 A, there may be a situation where the locations where the first group and the second group are present overlap each other after a specified time. In this case, the server is considered to transmit a request to stop traveling to the lead vehicle of the first group and the lead vehicle of the second group. However, depending on the group of the lead vehicle to which the request to stop traveling is transmitted, a traffic network may be excessively impacted when the group stops traveling.

In order to solve the above issue, the present disclosure provides a server configured to transmit, to a vehicle in a real world, a control signal that is based on predicted moving object information generated based on moving object information including location information of the vehicle. The server is configured to identify, as groups each consisting of a plurality of the vehicles that travels as a group, a first group and a second group different from the first group, based on the predicted moving object information,
calculate a degree of impact of each of the identified groups, the degree of impact of the group indicating a degree of impact the group has on a traffic network when the group is stopped,
estimate a presence range of each of the identified groups, the presence range being a range in which the group is estimated to be present in a virtual space after a predetermined specified time, the virtual space being a space in which locations of the vehicles are reproduced, and the virtual space being created based on the predicted moving object information;
determine whether the presence range of the first group overlaps the presence range of the second group; and
when the presence range of the first group overlaps the presence range of the second group, transmit a change request to change a vehicle speed to a lead vehicle of either the first group or the second group, whichever has a lower degree of impact, without transmitting a request to stop traveling to a lead vehicle of either the first group or the second group, whichever has a higher degree of impact.

According to the above configuration, the server transmits the change request to the lead vehicle of either the first group or the second group, whichever has a lower degree of impact. The server can thus avoid the presence range of the first group overlapping the presence range of the second group after the specified time. The server does not transmit the request to stop traveling to the lead vehicle of either the first group or the second group, whichever has a higher degree of impact. The server can thus reduce the impact on the traffic network caused by either the first group or the second group, whichever has a higher degree of impact, being stopped.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a communication system;

FIG. 2 is a flowchart illustrating a series of processes for generating predicted moving object information;

FIG. 3 is a flowchart illustrating a series of processes for determining a group;

FIG. 4 is a flowchart illustrating a series of processes for calculating the degree of impact;

FIG. 5 is a flow chart illustrating a series of processes including estimation of presence ranges; and

FIG. 6 is a flowchart illustrating a series of processes including transmission of a control signal to a leading vehicle.

### DETAILED DESCRIPTION OF EMBODIMENTS

### Outline of the Communication System

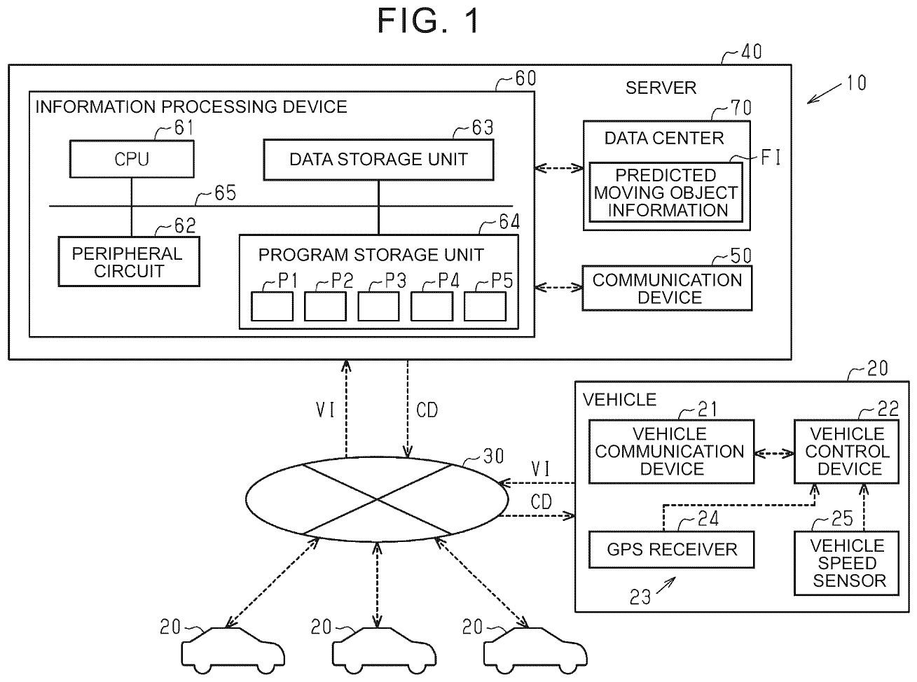

Hereinafter, an embodiment of a server will be described with reference to the drawings. Hereinafter, a communication system including a server will be described. As illustrated in FIG. 1, the communication system 10 includes a plurality of vehicles 20, a wireless communication network 30, and a server 40.

The vehicle 20 includes a vehicle communication device 21, a vehicle control device 22, and a plurality of information acquisition devices 23. The vehicle communication device 21 communicates with the server 40 through wireless communication via the wireless communication network 30. The vehicle control device 22 controls communication of the vehicle communication device 21.

The plurality of information acquisition devices 23 acquire various types of information of the vehicle 20. The plurality of information acquisition devices 23 are a GPS receiving device 24 and a vehicle speed sensor 25. GPS receiving device 24 receives location information indicating the locations of the vehicles 20 from a GPS device. The location information is, for example, a coordinate value of latitude and longitude. The vehicle speed sensor 25 acquires the traveling speed of the vehicle 20 as the vehicle speed. Each information acquisition device 23 outputs the acquired information of the vehicle 20 to the vehicle control device 22.

The vehicle control device 22 controls the following travel of the vehicle 20. The vehicle control device 22 controls, by a user's operation, the following travel that follows the other vehicle 20 traveling in front. The vehicle control device 22 generates following information FD indicating that the vehicle is in follow-up travel when the vehicle is in follow-up travel.

The vehicle control device 22 acquires, as the moving object information VI, various kinds of information of the vehicle 20 acquired from the plurality of information acquiring devices 23, identification information indicating the vehicle 20, a time at which the various kinds of information are acquired, and following information FD of the vehicle 20. The moving object information VI is information of the vehicles 20 in a real world. The identification information indicating the vehicle 20 includes information indicating whether the vehicle 20 is in the large vehicle LV and whether the vehicle is in the emergency vehicle EV. The large vehicle LV is a vehicle 20 having a total weight of a predetermined weight or more, or a vehicle 20 whose seating capacity is a predetermined number of persons or more determined in advance by the occupant capacity. LV of large vehicles are large trucks, route buses, and the like. The emergency vehicle EV is, for example, an ambulance.

The vehicle control device 22 outputs the moving object information VI to the vehicle communication device 21. Then, the vehicular communication device 21 transmits the moving object information VI to the server 40. In FIG. 1, one vehicle 20 of the plurality of vehicles 20 is illustrated in detail, and the other vehicle 20 is illustrated in detail without detail. The vehicles 20 each transmits moving object information VI to the servers 40.

The server 40 is capable of communicating with a plurality of vehicles 20. The servers 40 acquire the plurality of moving object information VI from the plurality of vehicles 20. The server 40 can send a change request CD as a control signal based on the predicted moving object information FI generated based on the moving object information VI, which will be described later, to the vehicle 20. The server 40 includes a communication device 50, an information processing device 60, and a data center 70.

The communication device 50 communicates with a plurality of vehicles 20. The communication device 50 receives the moving object information VI transmitted from the vehicles 20. The communication device 50 outputs the received moving object information VI to the information processing device 60. Further, the communication device 50 transmits the information acquired from the information processing device 60 to the vehicle 20.

The information processing device 60 includes a CPU 61 as an executing device, peripheral circuitry 62, a data storage unit 63, a program storage unit 64, and a bus 65. The bus 65 communicatively connects CPU 61, the peripheral circuitry 62, the data storage unit 63, and the program storage unit 64 to each other. The peripheral circuit 62 includes a circuit that generates a clock signal that defines an internal operation, a power supply circuit, a reset circuit, and the like. The data storage unit 63 stores data generated in association with the operation of CPU 61. The program storage unit 64 stores a program P1 for generating the predicted moving object information FI, a program P2 for determining the group GR, a program P3 for calculating the degree of impact IF, a program P4 for calculating the presence range AR, and a program P5 for controlling the lead vehicle. CPU 61 performs information processing by executing various programs stored in the program storage unit 64.

The data center 70 stores the predicted moving object information FI. The predicted moving object information FI is information including a plurality of moving object information VI generated based on the moving object information VI of the plurality of vehicles 20 and after the time when the moving object information VI in the predetermined area is acquired. The predetermined area may be, for example, a range including one country, a range including only part of regions of one country, or a range including the entire world. That is, the predicted moving object information FI is a so-called digital twin. In addition, the data center 70 stores time-series data of the predicted moving object information FI generated by the information processing device 60. The data center 70 acquires the predicted moving object information FI generated by the information processing device 60 a plurality of times over time. As a result, the data center 70 stores the time-series data of the predicted moving object information FI.

### Generation of Predicted Moving Object Information

Next, generation of the predicted moving object information FI performed by the information processing device 60 will be described. CPU 61 repeatedly generates the predicted moving object information FI by repeatedly executing the program P1 for generating the predicted moving object information FI at a predetermined cycle. The predetermined period is defined as, for example, one minute.

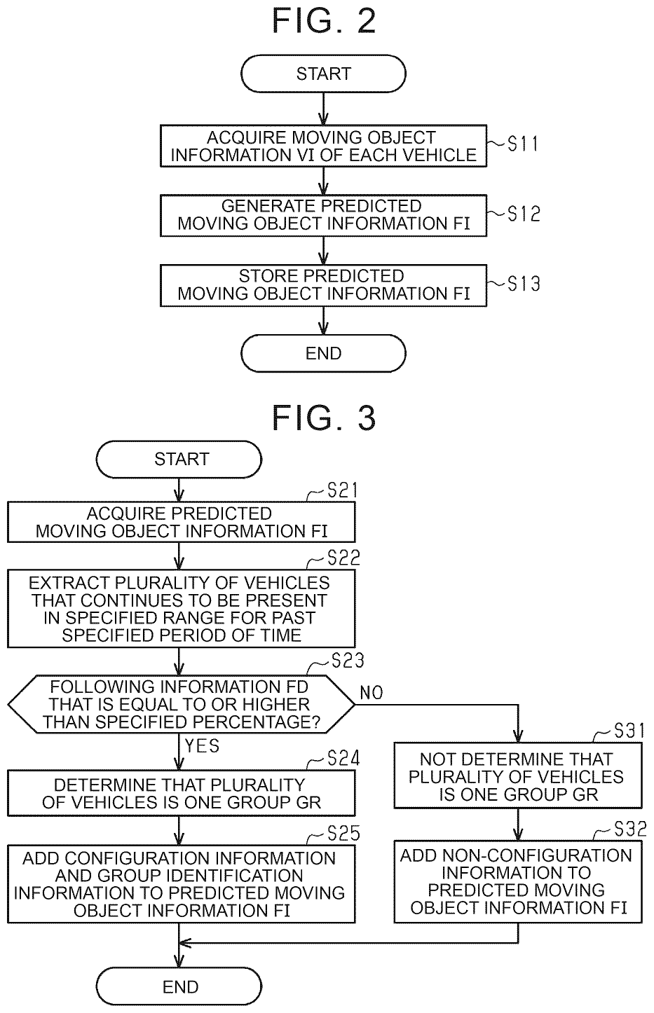

As illustrated in FIG. 2, when CPU 61 starts executing the program P1 for generating the predicted moving object information FI, it first performs a process S11. In S11, CPU 61 acquires moving object information VI of the vehicles 20 in the communication system 10. When acquiring the plurality of pieces of moving object information VI, CPU 61 acquires the moving object information VI of the respective vehicles 20 based on the identification information of the vehicles 20 included in the moving object information VI. Thereafter, CPU 61 advances the process to S12.

In S12, CPU 61 generates the predicted moving object information FI based on the plurality of acquired moving object information VI. Specifically, CPU 61 synchronizes the moving object information VI of the vehicles 20 by performing the following processes. The CPU 61 thus generates the predicted moving object information FI. First, CPU 61 refers to information indicating the acquired time for the plurality of acquired moving object information VI. Next, CPU 61 predicts the moving object information VI at the reference time by correcting the other pieces of moving object information VI by the difference of the times using the time of the moving object information VI having the newest acquired time as the reference time. For example, CPU 61 is corrected based on a moving object information VI such as a previous vehicle speed.

Then, CPU 61 generates various kinds of predicted information of the moving object information VI as the predicted moving object information FI. As a result, CPU 61 acquires the moving object information VI of the plurality of vehicles 20 synchronized with the reference time as the predicted moving object information FI. Thereafter, CPU 61 advances the process to S13.

In S13, CPU 61 stores the generated predicted moving object information FI in the data center 70. Thereafter, CPU 61 ends the series of processes. Accordingly, the data center 70 stores the acquired predicted moving object information FI. The data center 70 acquires and stores the predicted moving object information FI at predetermined intervals by CPU 61 repeating the program P1 for generating the predicted moving object information FI. Therefore, the data center 70 stores the time-series data of the predicted moving object information FI.

### Judgment of the Group

Next, the determination of the group GR of vehicles the group traveling performed by the information processing device 60 will be described.

CPU 61 repeatedly executes the program P2 for determining the group GR at a predetermined cycle. The predetermined period is defined as, for example, one minute. Accordingly, CPU 61 determines the vehicle 20 constituting the group GR and the vehicle 20 not constituting the group GR among the plurality of vehicles 20 in the predetermined area.

As shown in FIG. 3, when CPU 61 starts executing P2 of the determination program of the group GR, it starts S21 process. In S21, CPU 61 acquires data of the time-series data of the predicted moving object information FI in the data center 70 for a predetermined time period. The past predetermined period is, for example, 10 minutes. Thereafter, CPU 61 advances the process to S22.

In S22, CPU 61 extracts a plurality of vehicles 20 that continue to exist within a predetermined range for a predetermined period in the past, based on the time-series data of the predicted moving object information FI acquired by S21 for a predetermined period in the past. The specified range is, for example, a range in which the distance between the plurality of vehicles 20 is within 100 meters. Thereafter, CPU 61 advances the process to S23. In S22, when CPU 61 cannot extract the plurality of vehicles 20, CPU 61 adds non-configuration information indicating that the group GR is not configured to the predicted moving object information FI for all the vehicles 20, and ends the series of processes.

In S23, CPU 61 determines whether the number of vehicles 20 having a specified ratio or more among the plurality of vehicles 20 extracted by S22 is following. For example, the specified ratio is set at 80%. Specifically, CPU 61 determines whether the following information FD is included in the moving object information VI of the plurality of vehicles 20 extracted by S22. Then, CPU 61 compares the number of moving object information VI including the following information FD with the number extracted by S22.

When the following information FD is equal to or larger than the specified ratio (S23: YES), CPU 61 advances the process to S24. In S24, CPU 61 determines the plurality of vehicles 20 extracted in S22 as a group GR traveling as a group. Thereafter, CPU 61 advances the process to S25.

In S25, regarding a plurality of vehicles 20 determined to be one group GR in S24, CPU 61 adds configuration information indicating that these vehicles 20 form the group GR and group identification information identifying the group GR consisting of these vehicles 20 to the predicted moving object information FI. Thereafter, CPU 61 ends the series of processes.

On the other hand, when the following information FD is not equal to or larger than the specified ratio (S23: YES), CPU 61 advances the process to S31. In S31, CPU 61 does not determine the plurality of vehicles 20 extracted by S22 as one group. Thereafter, CPU 61 advances the process to S32.

In S32, CPU 61 adds, to the predicted moving object information FI, non-configuration information indicating that the group GR is not configured for the plurality of vehicles 20 that have not been determined to be one group GR in S31. Thereafter, CPU 61 ends the series of processes. In this way, the program P2 for determining the group GR is executed so that the predicted moving object information FI includes information indicating whether the group GR is configured.

### Calculation of Degree of Impact

Next, the calculation of the degree of impact IF of the group GR performed by the information processing device 60 will be described. CPU 61 repeatedly executes the program P3 for calculating the degree of impact IF at predetermined cycles. The predetermined period is defined as, for example, one minute. The degree of impact IF indicates the degree of impact on the traffic network in a predetermined area when the group GR to be calculated is stopped. Thus, CPU 61 calculates the degree of impact IF for each group GR configured in a predetermined area.

Specifically, CPU 61 identifies the first group GR1 and the second group GR2 by referring to the information identifying the group GR included in the predicted moving object information FI. The CPU 61 calculates a degree of impact IF of the first group GR1 and a degree of impact IF of the second group GR2.

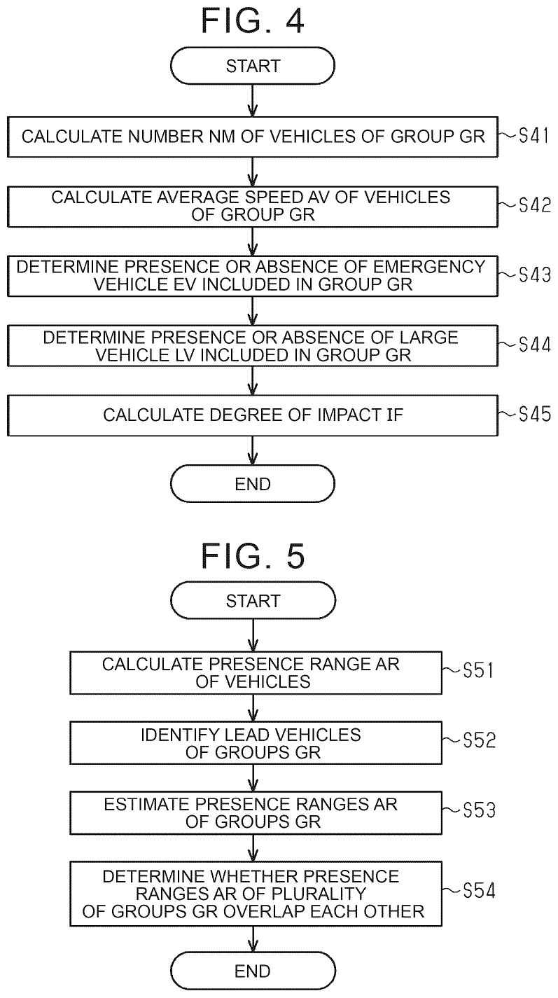

As illustrated in FIG. 4, when the CPU 61 starts executing the program P3 for calculating the degree of impact IF, the CPU 61 first starts the process of S41. In S41, CPU 61 calculates the number NM of vehicles 20 constituting the group GR whose degree of impact IF is to be calculated. Specifically, CPU 61 refers to the predicted moving object information FI and calculates the number NM of vehicles 20 having the information for identifying the group GR whose degree of impact IF is to be calculated. Thereafter, CPU 61 advances the process to S42.

In S42, CPU 61 calculates the average speed AV of the vehicles 20 included in the group GR. Specifically, CPU 61 acquires the speeds of the vehicles 20 having the information for identifying the group GR to be calculated by referring to the predicted moving object information FI of the vehicle 20 included in the group GR to be calculated. Next, CPU 61 calculates an average of the acquired speeds of the plurality of vehicles 20 as an average speed AV of the vehicles 20 included in the group GR. Thereafter, CPU 61 advances the process to S43.

In S43, CPU 61 determines whether there is an emergency vehicle EV included in the group GR whose degree of impact IF is to be calculated. Specifically, CPU 61 determines whether various kinds of information of the predicted moving object information FI of the vehicle 20 included in the group GR include information indicating that the vehicle is in an emergency vehicle EV. Thereafter, CPU 61 advances the process to S44.

In S44, CPU 61 calculates whether there is a large vehicle LV in the group GR whose degree of impact IF is to be calculated. CPU 61 determines whether various kinds of information of the predicted moving object information FI of the vehicle 20 included in the group GR include information indicating that the vehicle is a large vehicle LV. Thereafter, CPU 61 advances the process to S45.

In S45, CPU 61 calculates the degree of impact IF of the group GR to be calculated. Specifically, CPU 61 calculates the degree of impact IF larger as the number of vehicles 20 constituting the group GR to be calculated increases. CPU 61 calculates the degree of impact IF to be larger as the average speed AV of the vehicles 20 constituting the group GR whose degree of impact IF is to be calculated is larger. When the emergency vehicle EV is included in the group GR to be calculated, CPU 61 calculates the degree of impact IF larger than when the emergency vehicle EV is not included. When the large vehicle LV is included in the group GR to be calculated, CPU 61 calculates the degree of impact IF larger than when the large vehicle LV is not included. Thereafter, CPU 61 adds information indicating the degree of impact IF of the group GR to the predicted moving object information FI, and ends the series of processes.

### Calculation of Presence Range

Next, the calculation of the presence range AR of the group GR performed by the information processing device 60 will be described. The presence range AR is a range in which it is estimated that the target vehicle 20 or the group GR exists in the virtual space constructed based on the predicted moving object information FI. The virtual space is a space that is created based on the predicted moving object information FI and in which the locations of the plurality of vehicles 20 are reproduced.

CPU 61 repeatedly executes the program P4 for calculating the presence range AR at a predetermined cycle. The predetermined period is defined as, for example, one minute. Thus, CPU 61 calculates the presence range AR of each group GR and determines whether the presence range AR of the first group GR1 overlaps the presence range AR of the second group GR2.

As illustrated in FIG. 5, when CPU 61 starts executing the program P4 for calculating the presence range AR, it first executes S51 process. In S51, CPU 61 calculates a presence range AR of the vehicles 20 in which the vehicles 20 are present after a predetermined specified time, based on the predicted moving object information FI. The presence range AR of the vehicles 20 is a range in which the probability of the vehicle 20 being present after the specified time is equal to or greater than a predetermined probability. The extent of the presence range AR varies depending on the uncertainty of the measure included in the respective information of the moving object information VI. The measurement uncertainty is based on, for example, errors resulting from the accuracy in the method of measuring the location information and the vehicle speed. The greater the error, the greater the uncertainty. Also, the higher the vehicle speed, the greater the uncertainty. Then, the size of the presence range AR becomes wider as the uncertainty becomes larger. Note that the specified time is determined as a time period in which AR of the presence ranges of the groups GR can be avoided from overlapping each other by controlling the traveling of the groups by testing or simulating in advance. For example, the specified time is 1 minute. CPU 61 calculates the presence range AR of the vehicles 20, and then advances the process to S52.

In S52, CPU 61 identifies the lead vehicles of each group GR based on the predicted moving object information FI and the presence range AR calculated by S51. For example, CPU 61 first estimates a row arranged along the road from the presence range AR of the vehicles 20 constituting the group GR. Next, CPU 61 estimates a direction in which the location of the vehicle 20 in the predicted moving object information FI moves to the presence range AR. Then, CPU 61 identifies, as the leading vehicle, the vehicle 20 at the estimated leading end among the vehicles 20 at both ends of the estimated row. Thereafter, CPU 61 advances the process to S53.

In S53, CPU 61 estimates the presence range AR of each group GR after the specified time. The presence range AR of the group GR is the smallest range including all the presence range AR of all the vehicles 20 constituting the group GR. Thereafter, CPU 61 advances the process to S54.

In S54, CPU 61 determines whether the presence range AR of the plurality of group GR overlap each other in the virtual space. Specifically, CPU 61 determines whether the presence ranges AR of the groups GR estimated in S53 overlap each other in the virtual space. Then, the two groups GR whose presence ranges AR are determined to overlap each other are identified as the first group GR1 and the second group GR2. Therefore, in S54, CPU 61 determines whether the presence range AR of the first group GR1 after the specified time overlaps the presence range AR of the second group GR2 after the specified time. Thereafter, CPU 61 ends the series of processes.

### Transmission of Control Signals to the Leading Vehicle

Next, transmission of the control signal from the information processing device 60 to the lead vehicle of the group GR will be described. When CPU 61 determines that the presence range AR of the first group GR1 and the second group GR2 that are two groups GR out of the plurality of groups GR overlap each other by S54 process, it starts executing the program P5 for controlling the lead vehicle. That is, when CPU 61 determines that the presence range AR of the first group GR1 overlaps the presence range AR of the second group GR2 in the virtual space, it starts executing the program P5 for controlling the lead vehicle.

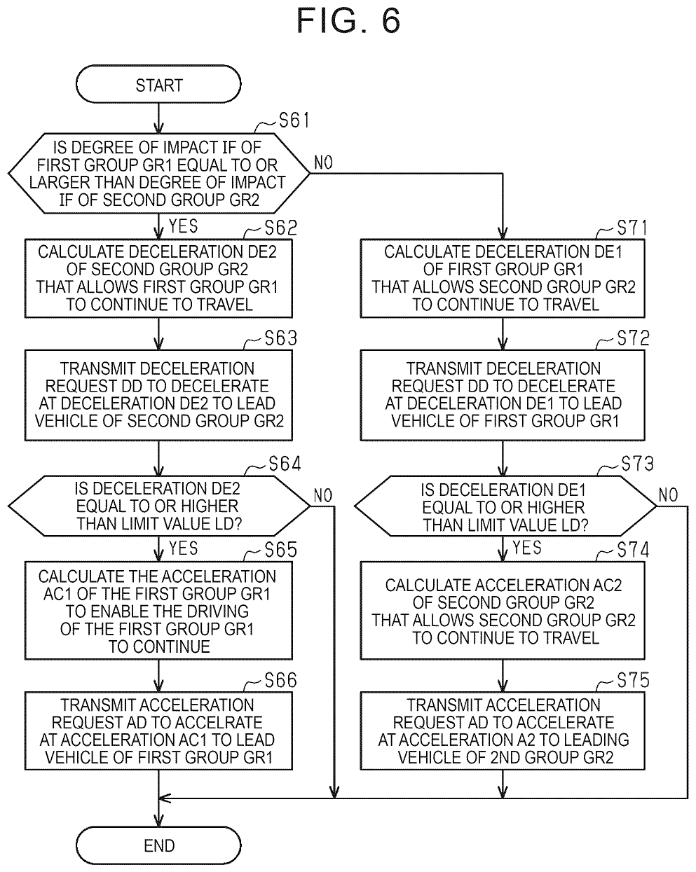

As shown in FIG. 6, when CPU 61 starts executing the program P5 for controlling the lead vehicle, S61 process is started first. In S61, CPU 61 determines whether the degree of impact IF of the first group GR1 is equal to or greater than the degree of impact IF of the second group GR2. When the degree of impact IF of the first group GR1 is equal to or greater than the degree of impact IF of the second group GR2 (S61: YES), CPU 61 advances the process to S62.

In S62, CPU 61 calculates a deceleration DE2 of the second group GR2 for enabling the traveling of the first group GR1 to continue. Specifically, when the first group GR1 continues traveling in the current state, CPU 61 calculates the minimum deceleration at which the presence range AR of the first group GR1 does not overlap the presence range AR of the second group GR2 as the deceleration DE2 of the second group GR2. It should be noted that the minimum deceleration is a deceleration with a minimum absolute value at which the vehicle speed changes to a small degree. Thereafter, CPU 61 advances the process to S63.

In S63, CPU 61 transmits a change request CD, which is a deceleration request DD requesting deceleration in the deceleration DE2 of the second group GR2, to the lead vehicle of the second group GR2. That is, the deceleration request DD is a request for stopping the lead vehicle of the second group GR2 or reducing the vehicle speed. Thereafter, CPU 61 advances the process to S64.

In S64, CPU 61 determines whether the deceleration DE2 of the second group GR2 calculated by S62 is equal to or greater than the limit value LD. The limit value LD is the greatest deceleration that can be decelerated. When the deceleration DE2 of the second group GR2 is less than the limit value LD (S64: NO), CPU 61 ends the series of processes. When the deceleration DE2 of the second group GR2 is equal to or greater than the limit value LD (S64: YES), CPU 61 advances the process to S65.

In S65, CPU 61 calculates an acceleration AC1 of the first group GR1 for enabling the traveling of the first group GR1 to continue. Specifically, when the second group GR2 starts the deceleration in the limit value LD, CPU 61 calculates the minimum acceleration at which the presence range AR of the first group GR1 does not overlap the presence range AR of the second group GR2 as the acceleration AC1 of the first group GR1. Note that the minimum acceleration is an acceleration with a minimum absolute value at which the vehicle speed changes to a large degree. Thereafter, CPU 61 advances the process to S66.

In S66, CPU 61 transmits an acceleration request AD requesting acceleration in the acceleration AC1 to the lead vehicles of the first group GR1. That is, CPU 61 does not transmit a request for stopping the travel to the lead vehicles of the first group GR1. Thereafter, CPU 61 ends the series of processes.

When the degree of impact IF of the first group GR1 is less than the degree of impact IF of the second group GR2 (S61: NO), CPU 61 advances the process to S71. In S71, CPU 61 calculates a deceleration DE1 of the first group GR1 for enabling the traveling of the second group GR2 to continue. Specifically, if the second group GR2 continues traveling in the current state, CPU 61 calculates the minimum deceleration at which the presence range AR of the first group GR1 does not overlap the presence range AR of the second group GR2 as the deceleration DE1 of the first group GR1. Thereafter, CPU 61 advances the process to S72.

In S72, CPU 61 transmits a change request CD, which is a deceleration request DD requesting deceleration in the deceleration DE1 of the first group GR1, to the lead vehicle of the first group GR1. Thereafter, CPU 61 advances the process to S73.

In S73, CPU 61 determines whether the deceleration DE1 of the first group GR1 is greater than or equal to the limit value LD. When the deceleration DE1 of the first group GR1 is less than the limit value LD (S73: NO), CPU 61 ends the series of processes. When the deceleration DE1 of the first group GR1 is equal to or greater than the limit value LD (S73: YES), CPU 61 advances the process to S74.

In S74, CPU 61 calculates an acceleration AC2 of the second group GR2 for enabling the traveling of the second group GR2 to continue. Specifically, when the first group GR1 starts the deceleration in the limit value LD, CPU 61 calculates the minimum acceleration at which the presence range AR of the first group GR1 does not overlap the presence range AR of the second group GR2 as the acceleration AC2 of the second group GR2. Thereafter, CPU 61 advances the process to S75.

In S75, CPU 61 transmits an acceleration request AD requesting acceleration in the acceleration AC2 to the lead vehicles of the second group GR2. That is, CPU 61 does not transmit a request for stopping the travel to the lead vehicles of the second group GR2. Thereafter, CPU 61 ends the series of processes.

### Effects of Embodiment

(1) When determining that the presence range AR of the first group GR1 overlaps the presence range AR of the second group GR2, CPU 61 transmits a deceleration request DD to the lead vehicle of the first group GR1 having a lower degree of impact IF. Thus, it is possible to avoid the presence range AR of the first group GR1 overlapping the presence range AR of the second group GR2 after the specified time. Then, CPU 61 does not transmit a request to stop the driving to the lead vehicles of the second group GR2 having a higher degree of impact IF. Accordingly, it is not necessary to stop traveling of the second group GR2 having a higher degree of impact IF. Consequently, the servers 40 can reduce the impact on the traffic network caused by either the first group GR1 or the second group GR2, whichever group GR has a higher degree of impact IF, being stopped.

(2) CPU 61 calculates the degree of impact IF larger as the number of vehicles 20 in the group GR whose degree of impact IF is to be calculated increases. Therefore, it is possible to suppress an increase in the effect caused by stopping traveling of the group GR consisting of a large number of vehicles 20.

(3) CPU 61 calculates the degree of impact IF to be larger as the average speed AV of the vehicles 20 of the group GR whose degree of impact IF is to be calculated is larger. Therefore, it is possible to prevent the group GR having a large average speed AV from having a large effect of stopping the traveling.

(4) When it is determined that the presence range AR of the first group GR1 overlaps the presence range AR of the second group GR2, CPU 61 transmits the acceleration request AD to the lead vehicle of the second group GR2 having a higher degree of impact IF. Therefore, a larger difference can be generated between the traveling speed of the second group GR2 and the traveling speed of the first group GR1.

### Other Embodiments

The present embodiment can be realized with the following modifications. The present embodiment and the following modifications can be combined with each other within a technically consistent range to be realized.
The method of calculating the degree of impact IF is not limited to the embodiment described above. For example, when calculating the degree of impact IF, CPU 61 may calculate the degree of impact IF of the group GR including the emergency vehicle EV to be larger than the degree of impact IF of the group GR not including the emergency vehicle EV. For example, CPU 61 may calculate the degree of impact IF to be larger when the CPU 61 calculates the degree of impact IF as the average value of the sizes of the vehicles 20 constituting the group GR is larger. That is, CPU 61 may calculate the degree of impact IF regardless of a part or all of the number NM of the vehicle 20, the average speed AV of the vehicle 20, the presence or absence of the emergency vehicle EV, and the presence or absence of the large vehicle LV.
CPU 61 may omit S64 to S66 and S73 to S75 operations. That is, CPU 61 may not transmit the acceleration request AD.
CPU 61 may not determine for all group GR whether the presence ranges AR overlap each other. For example, CPU 61 may identify the first group GR1 and the second group GR2 and determine whether the identified presence range AR of the first group GR1 overlaps the presence range AR of the identified second group GR2. Regarding the group GR whose degree of impact IF is larger than a specified value, CPU 61 may determine whether the presence range of this group GR overlaps the presence range AR of any other group GR.
When CPU 61 does not transmit the acceleration request AD, it may transmit a request for greatly changing the vehicle speed as the change request CD. In this case, if the request to stop traveling is not transmitted to the group GR having a higher degree of impact IF, the group GR having a higher degree of impact IF can be made to continue to travel while avoiding the presence range AR of the first group GR1 and the presence range AR of the second group GR2 overlapping each other.
The method of generating the predicted moving object information FI is not limited to the embodiment described above. For example, the reference time may be set as a time that is later than the acquisition time of all the vehicles 20. Even in this situation, CPU 61 can generate the predicted moving object information FI after acquiring the moving object information VI.
The moving object information VI is not limited to information acquired from the vehicles 20. For example, the moving object information VI may be information obtained by the servers 40 from the cameras regarding the vehicles 20 obtained by the cameras provided in the traffic network.
The information processing device 60 may be configured as a circuitry including one or more processors that execute various processes in accordance with a computer program (software). Note that the information processing device 60 may be configured as a circuit including one or more dedicated hardware circuits such as an application-specific integrated circuit (ASIC) that executes at least part of the various processes, or a combination thereof. The processor includes a CPU and a memory such as a random access memory (RAM) and a ROM. The memory stores a program code or an instruction configured to execute the CPU to perform processes. The memory, that is, the computer-readable medium includes any available media that can be accessed by a general purpose or special purpose computer.

What is claimed is:

1. A server configured to transmit, to a vehicle in a real world, a control signal that is based on predicted moving object information generated based on moving object information including location information of the vehicle, the server being configured to
identify, as groups each consisting of a plurality of the vehicles that travels as a group, a first group and a second group different from the first group, based on the predicted moving object information,
calculate a degree of impact of each of the identified groups, the degree of impact of the group indicating a degree of impact the group has on a traffic network when the group is stopped,
estimate a presence range of each of the identified groups, the presence range being a range in which the group is estimated to be present in a virtual space after a predetermined specified time, the virtual space being a space in which locations of the vehicles are reproduced, and the virtual space being created based on the predicted moving object information,
determine whether the presence range of the first group overlaps the presence range of the second group, and
when the presence range of the first group overlaps the presence range of the second group, transmit a change request to change a vehicle speed to a lead vehicle of either the first group or the second group, whichever has a lower degree of impact, without transmitting a request to stop traveling to a lead vehicle of either the first group or the second group, whichever has a higher degree of impact.

2. The server according to claim 1, wherein the degree of impact is calculated in such a manner that the group consisting of a larger number of the vehicles has a larger degree of impact.

3. The server according to claim 1, wherein the degree of impact is calculated in such a manner that the group whose average speed of the vehicles is higher has a higher degree of impact.

4. The server according to claim 1, wherein the change request is a deceleration request to reduce the vehicle speed.

5. The server according to claim 4, wherein the server is further configured to, when the presence range of the first group overlaps the presence range of the second group, transmit an acceleration request to increase the vehicle speed to the lead vehicle of either the first group or the second group, whichever has the higher degree of impact.
